(19) United States
(12) Patent Application Publication
(10) Pub. No.: US 2011/0320441 A1
(43) Pub. Date: Dec. 29, 2011

(54) ADJUSTING SEARCH RESULTS BASED ON USER SOCIAL PROFILES

(75) Inventors: Min-John Lee, Santa Cruz, CA (US); David James Gemmell, Danville, CA (US); Ashok K. Chandra, Saratoga, CA (US); Vincent Vergonjeanne, Paris (FR); Emre M. Kiciman, Seattle, WA (US)

(73) Assignee: Microsoft Corporation, Redmond, WA (US)

(21) Appl. No.: 12/823,587

(22) Filed: Jun. 25, 2010

(51) Int. Cl. G06F 17/30

(52) U.S. Cl. 707/723; 707/E17.014; 707/759; 707/722

(57) ABSTRACT

Many contemporary computing scenarios involve the submission by a user of a search query to be applied to a data set (such as a set of web pages indexed by a web search engine.) Additionally, many users participate in social networking and have generated a social profile, including demographic information, interests, and associations with other users who also have social profiles. It may be advantageous to improve the presentation of search results from search queries by adjusting the search queries according to a prediction of user interest of the user in the topics associated with respective search results, based on the information in the social profile of the user. For example, search results relating to topics in which the user or the user's friends have expressed an interest within the social network may be presented before other search results, thereby improving the relevance of the search results to the user.

### BACKGROUND

Within the field of computing, many scenarios involve the presentation of a set of search results in response to a search query submitted by a user. The user may submit the search query against many types of data sets, including a set of web resources (including a small set of pages, such as an intranet or the pages of a website), a set of media objects such as images or musical performances, a set of records in a database, or a set of advertisements for various products and services. The search results may then be presented to the user in many ways (e.g., as a set of uniform resource identifiers (URIs) to the search results comprising web resources, or as a tiled set of thumbnails representing various images selected from an image database.)

A more recent trend within the field of computing is the rise of social networking, wherein users may establish associations representing relationships with other users, and may share data of interest with all or some associated users. In this context, a user may establish a social profile comprising data that identifies various aspects of the user to associated users, such as demographic information, a set of interests such as hobbies or professional skills, and a set of resources that are interesting to the user. The social profile of the user may differ significantly from a private profile of the user, which may include private information that the user does not wish to share with any other users. By contrast, users may consent to having some aspects of his or her social profile more broadly shared; e.g., a user might author a message (such as a personal status, a note about a particular topic, or a message directed to another user) that may initially be accessible only to users who are associated with the user, but may permit an associated user to repost the message for access by all of the users associated with the associated user (e.g., a friend of a user may be permitted to take the user's message and repost it to grant access to the friend's friends.) In this manner, data shared over a social network (and, in particular, data comprising the social profile of a user) may be propagated in select ways to others via the social network.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In view of the widespread use of search engines to apply queries to various data sets and the emerging significance of social networking, it may be advantageous to facilitate the fulfillment of a search query received from a user by utilizing the information comprising the user's social profile. As a first example, the search query may be personalized based on information in the user's social profile, such as the user's interests and demographic information. As a second example, the search query may be personalized based on information in the social profiles of users with whom the user is affiliated. As a third example, the search results of the user, and the user's response to the search results (e.g., reviewing particular search results) may be evaluated, and may subsequently inform the presentation of search results for search queries submitted by other users who are associated with the user.

These and other scenarios suggest some potential advantages of utilizing social network information while handling search queries and search results. In particular, this information may be utilized to adjust the search results of a search query. For example, when the user submits a search query against a data set, a search engine may apply the search query to the data set to retrieve a set of search results. An embodiment of these techniques may then identify one or more topics associated respective the search results, and, based on the social profile of the user, may predict which topics may be of interest to the user. The embodiment may then adjust the search results, such that the search results having a higher probability of appealing to the interests of the user may appear in the set of search results before other search results having a lower probability of interest.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a presentation of an exemplary scenario featuring a user of a social network who may submit a search query for application against a data set.

FIG. 2 is an illustration of an exemplary scenario featuring a presentation of search results in response to a query submitted by a user having a social profile in accordance with the techniques presented herein.

FIG. 3 is a flow diagram illustrating an exemplary method of presenting search results in response to a search query received from a user having a social profile.

FIG. 4 is a component block diagram illustrating an exemplary system for presenting search results in response to a search query received from a user having a social profile.

FIG. 5 is an illustration of an exemplary computer-readable medium comprising processor-executable instructions configured to embody one or more of the provisions set forth herein.

FIG. 6 is an illustration of an exemplary scenario featuring a prediction of user interest in various topics associated with search results according to the techniques presented herein.

FIG. 7 is an illustration of an exemplary scenario featuring two presentations of search results adjusted in view of the social profile of the user in accordance with the techniques presented herein.

FIG. 8 is an illustration of an exemplary scenario featuring another presentation of search results adjusted in view of the social profile of the user in accordance with the techniques presented herein.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Within the field of computing, two common scenarios and sets of techniques have arisen that, according to the present disclosure, may share a nexus of functionality. The first scenario involves the application of a search query submitted by a user to a data set to produce a set of search results. Many such search engines have been devised to apply search queries to many types of data sets (e.g., a web search engine configured to index a set of web resources, such as websites of various web pages; a media database configured to index various properties of a set of media objects, such as images, music, or videos; and an advertisement database configured to select advertisements from an advertisement set that are targeted based on the details of a user.) Many types of queries may also be accepted and applied to these data sets, such as keyword queries, natural language queries (sometimes received as speech through a speech recognition engine), logical queries specifying sets of criteria connected by Boolean operators, and queries specified in a search query language, such as a structured query language (SQL) or variant thereof. The search results may also be provided in many forms, such as a simple list of uniform resource identifiers (URIs) of matching web resources, a tiled set of thumbnails of matching images, or a preview of a matching video.

The second scenario involves a social network, where each user may each create a social profile that represents and describes the user, and where the users may then establish associations representing various types of relationships with other users (such as family relationships, friendships, acquaintanceships, and professional or academic relationships.) Users of the social network may also share information with other users via the social network, such as public demographic information (e.g., the individual's age and race), academic and career history, and interests (e.g., hobbies, skills, or preferences in books and music.) Users may also share messages of different types with other users via the social network, such as a status message, a note written about a particular topic, or a public message sent to another user. This context may differ significantly from other contexts involving a user profile, wherein the user may provide private information that is only shared or used in limited circumstances, such as the user's private messages with other users, credit card number, medical information, and private web search history. By contrast, the information comprising the social profile of the user is often intended to be shared. Some such information may be completely public and viewable by anyone, while other information may be shared only with associated users who are associated with the user by a relationship, and still other information may be shared only with a subset of associated users. However, a user may also permit associated users to share some of the information in the social profile with still others (e.g., a user may permit friends to “repost” or republish a message for viewing by any other users who have established associations with the friends.)

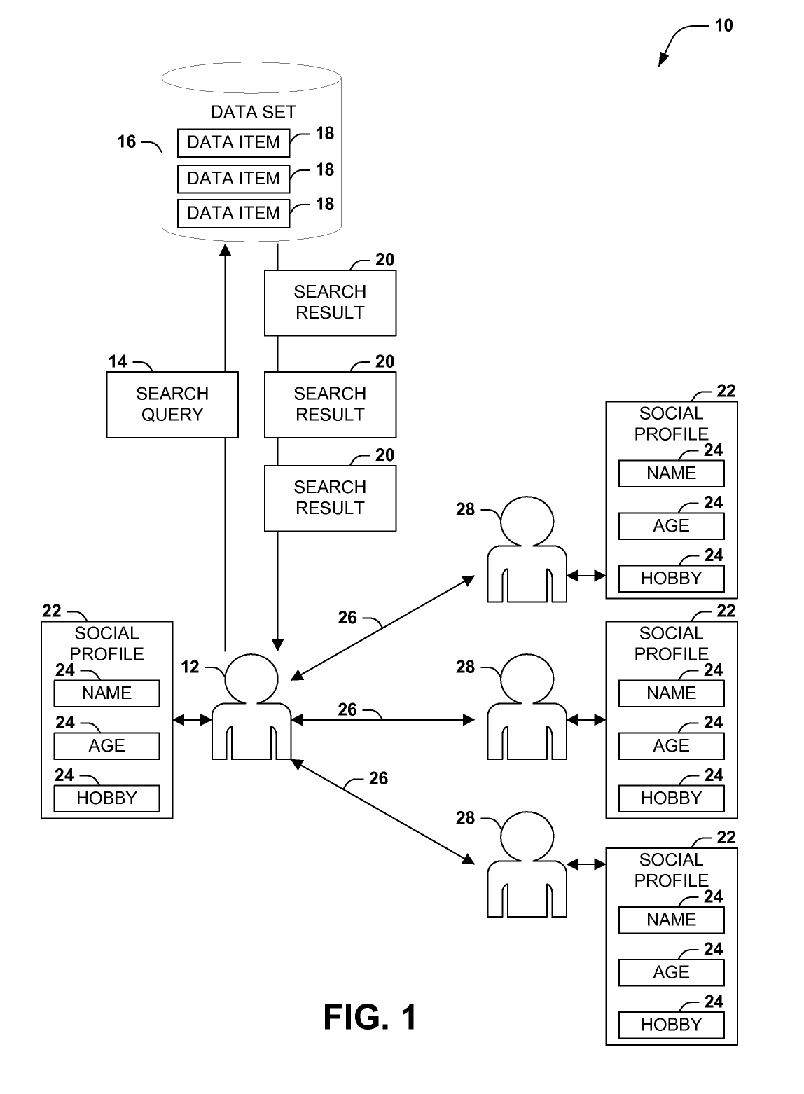

FIG. 1 presents an exemplary scenario 10 featuring a user 12 who has established an identity in a social network, and who wishes to search a data set for a particular set of items. In this exemplary scenario, the user 12 submits a search query 14 to a data set 16 having a set of data items 18, such as an indexed set of web resources (such as web pages), a set of media objects (such as images, video or audio recordings, or text documents), or a set of advertisements for various products or services. The data set 16 may apply the search query 14 by comparing the search criteria specified therein against the indexed data items 18, selecting data items 18 that match the criteria, and providing the selected data items 18 as search results 20. The search results 20 may be presented to the user 12 in many ways, e.g., as a set of links, such as uniform resource identifiers (URIs) identifying the matching web resources, a tiled set of thumbnails of various images, or a set of advertisements that may be embedded in various forms of content that may be presented to the user 12. Additionally, the user 12 may have generated a social profile 22, comprising various profile elements 24 that the user 12 wishes to share with other users 12. The user 12 may therefore establish associations 26 within the social network with one or more associated users 28. These associations 26 may comprise unidirectional associations (e.g., where the user 12 indicates an interest in content produced by the associated user 28) or bidirectional associations (e.g., where the user 12 and the associated user 28 agree on the existence and nature of the relationship therebetween, such as a familial, romantic, friend, acquaintance, academic, or professional relationship.) The user 12 may therefore share profile elements 24 of the social profile 22 with the associated users 28. The user 12 may be permitted to declare that these profile elements 24 may be accessible only to these associated users 28, or may permit the associated users 28 to share a profile element 24 with other individuals (such as other users 12 who have established associations 26 with the associated users 28), or may be publicly accessible to the world. Similarly, the user 12 may wish to view the profile elements 24 defined by the associated users 28, and thus may request and review the social profiles 22 of the associated users 28.

These scenarios may arise frequently and in many contexts in the field of computing. For example, a user 12 may, upon submitting a search query 14 for application against a data set 16, discover an interesting search result 20, and may then share the search result 20 with associated users 28 via the social network. However, these tasks often involve distinct actions; e.g., the interactions of the user 12 with the data set 16 may be isolated from and unaffected by the social network of the user 12 except when the user 12 explicitly transfers content from the data set 16 to the social network, and the social profile 22 of the user 12 may not influence the application of the search query 14 to the data set 16.

In view of the prevalence of search engines and social networking in contemporary computing, it may be advantageous to utilize certain aspects of each technique in the performance of the other. In particular, it may be advantageous for a data set 16, while processing a search query 14 submitted by a user 12, to identify data items 18 that may be of interest to the user 12 based on the social profile 22 of the user 12. As a first example, the user 12 may submit a search query 14 including an ambiguous keyword that might correspond to a city, a music band, and a technology product. By examining the social profile 22 of the user 12, the data set 16 may identify that the user 12 is not located anywhere near the city and does not appear to be interested in the type of music produced by the music band, but owns other products manufactured by the technology company that is producing the named product. The data set 16 may therefore determine that the user is more likely referring in the search query 14 to the technology product than the other options. As a second example, if the user 12 enters a search query 14 seeking a recommendation (e.g., “summer vacation cities”), the social profiles 22 of associated users 28 who are associated with the user 12 may be examined to predict an interest in a particular recommendation (e.g., “your friend Beth recently wrote this comment about this city . . . ” and “your friend John recently moved to this city . . . ”), and any search results 20 relating to these recommendations may be emphasized in the search result set presented to the user 12 over other search results 20.

In view of these aspects of search engines and social networking presented herein are techniques for facilitating each service through aspects of the other service. In particular, presented herein are techniques for improving the relevance of search results 20 to a user 12 based on the social profile 22 of the user 12 within the social network. These techniques involve applying the search query 14 to the data set 16 to identify search results 20, which often results in an ordering of the search results 20 based on criteria about the search results (e.g., the coincidence of the details of the search result 20 with the criteria of the search query 14, the reliability or popularity of the source of the search result 20, and the age of the search result 20.) Regarding these search results 20, the techniques presented herein involve evaluating each search result 20 to identify one or more topics associated with each search result 20. The social profile 22 of the user 12 may then be reviewed to predict a user interest of the user 12 in the topics associated with the search results 20. This prediction may involve, e.g., the profile elements 24 stored in the social profile 22 of the user 12 and the associations 26 of the user 12 with associated users 28, as well as the social profiles 22 of the associated users 28. Based on the prediction of user interest of the user 12 in respective search results 20, an embodiment of these techniques may then adjust the search results 20. For example, the search results 20 may be reordered to reflect a sorting based on the predicted user interest in the search results 20. The search results 20 may then be presented to the user 12 in an adjusted manner, such that search results 20 having a higher predicted user interest are presented before search results 20 having a lower predicted user interest. In this manner, the details of the user 12 identified in the social network may be utilized to improve the presentation of the search results 20 to the user 12.

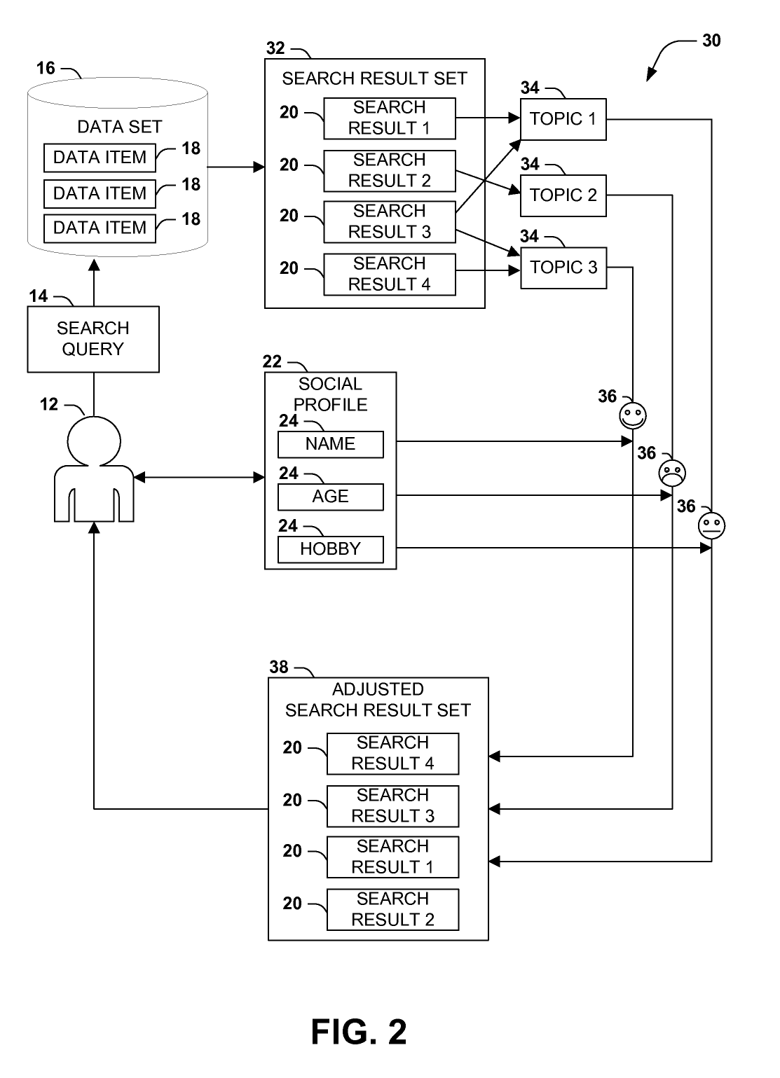

FIG. 2 presents an exemplary scenario 30 featuring an application of these techniques, wherein a user 12 submits a search query 14 to a data set 16. In accordance with these techniques, a search result set 32 may be generated comprising a set of search results 20, which may be positioned in a particular order (such as chronology, popularity, or correlation with the criteria of the search query 14) as determined by the data set 16. In accordance with the techniques presented herein, respective search results 20 may be evaluated to determine one or more topics 34 associated therewith. Next, the social profile 22 of the user 12 may be consulted to identify a user interest 36 in the respective topics 34 of each search results 20. For example, a first search result 20 may be identified with a first topic 34 in which the user 12 appears to be ambivalent; a second search result 20 may be associated with a topic 34 that the user 12 actively dislikes; a third search result 20 may be associated with two topics 34, one of which the user 12 appears to likes and the other of which the user 12 appears to be ambivalent; and a fourth search result 20 may be associated with a topic 34 that the user 12 appears to like. In accordance with these identified user interests 36 identified from the social profile 22, the search results 20 may then be adjusted into an adjusted search result set 38. In this adjusting, the fourth search result 20 (which the user 12 is likely to like, based on the topic 34 associated with the search result 20) appears before the first search result 20 (which relates to a topic 34 in which the user 12 has not expressed a user interest 36), which in turn appears before the second search result 20 (which is associated with a topic 34 that the user 12 actively dislikes.) The adjusted search result set 38 may then be presented to the user 12 in order to improve the matching of the search results 20 with the user interests 36 of the user 12. Additional refinements may also be included; e.g., if the user 12 significantly dislikes the second topic 34, then any search results 20 pertaining thereto (such as the second search result 20) may be altogether removed from the search result set.

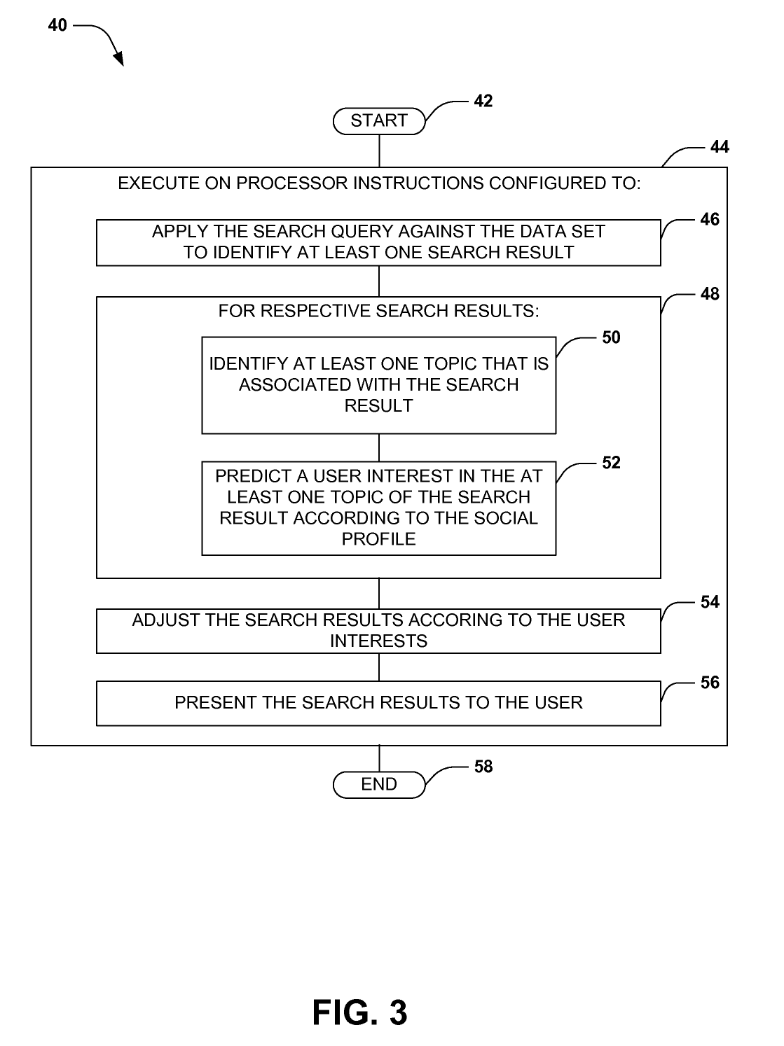

FIG. 3 presents a first embodiment of the techniques presented herein, comprising an exemplary method 40 of presenting search results 20 of a data set 16 in response to a search query 14 submitted by a user 12 having a social profile 22. The exemplary method 40 may be performed by a device having a processor, and may be implemented in many ways (e.g., as a set of instructions stored in a volatile or nonvolatile memory storage device.) The exemplary method 40 begins at 42 and involves executing 44 on the processor instructions configured to perform the search and present the search results 20 according to the techniques presented herein. In particular, the instructions are configured to apply 46 the search query 14 against the data set 16 to identify at least one search result 20. The instructions are also configured to, for respective search results 48, identify 50 at least one topic 34 that is associated with the search result 48, and predict 52 a user interest 36 in the topics 34 identified as associated with the search result 20, according to the social profile 22 of the user 12. Based on these predictions, the instructions are configured to adjust 54 the search results 20 according to the user interests 36, and to present 56 the search results 20 to the user 12. In this manner, the exemplary method 40 improves the presentation of search results 20 to the user 12 based on the information in the social profile 22, and so ends at 58.

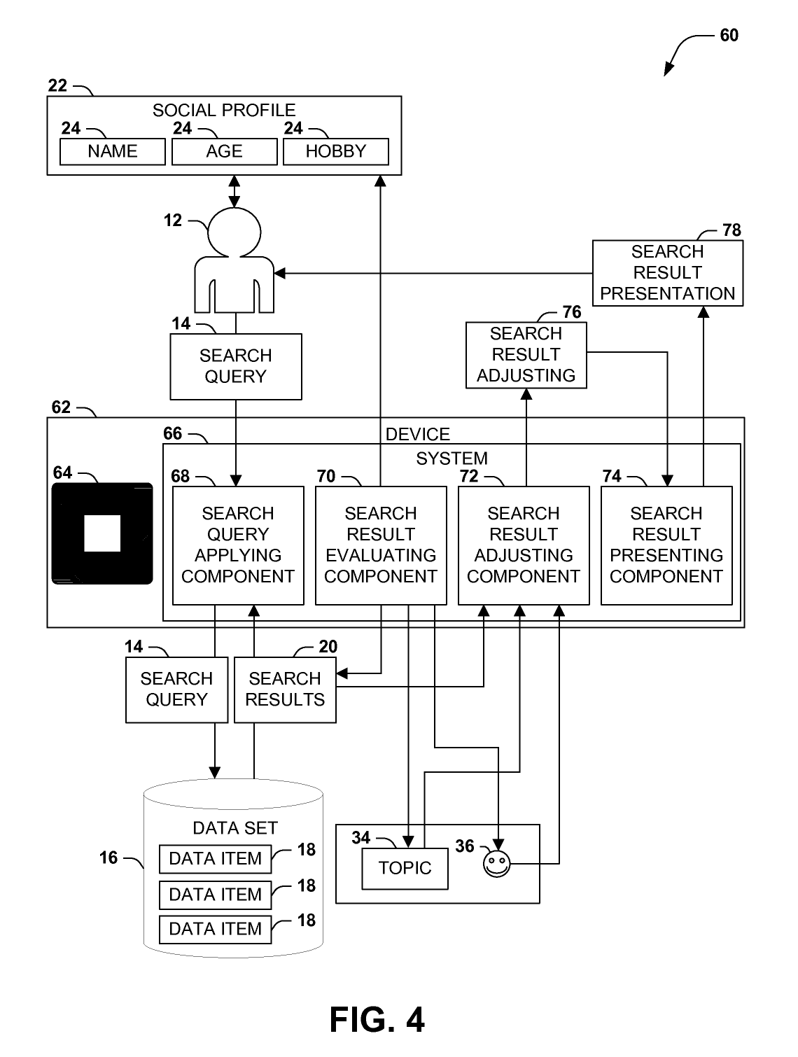

FIG. 4 presents a second exemplary embodiment of these techniques, illustrated as an exemplary system 66 configured to present search results 20 of a data set 16 in response to a search query 14 submitted by a user 12 having a social profile 22. The exemplary system 66 operates on a device 62 having a processor 64, and may be implemented, e.g., as a software architecture comprising a set of interoperating components stored in a volatile or nonvolatile memory device (e.g., system RAM, a hard disk drive, an optical disc, a flash memory device, or a field programmable gate array (FPGA)), and executable on the processor 64 of the device 62. The exemplary system 66 comprises a search query applying component 68, which is configured to apply the search query 14 against the data set 16 to identify at least one search result 20. The exemplary system 66 also comprises a search result evaluating component 70, which is configured to, for respective search results 20, identify at least one topic 34 that is associated with the search result 20, and predict a user interest 36 in the at least one topic 34 of the search result 20 according to the social profile 22 of the user 12. The exemplary system 66 also comprises a search result adjusting component 72, which is configured to adjust the search results 20 according to the user interests 36, and a search result presenting component 74, which is configured to present the search results 20 (as adjusted by the search result adjusting component 72) to the user 12. In this manner, the components of the exemplary system 66 may cause the device 62 to apply the search query 14 and present search results 20 in view of the user interests 36 of the user 12 in the search results 20.

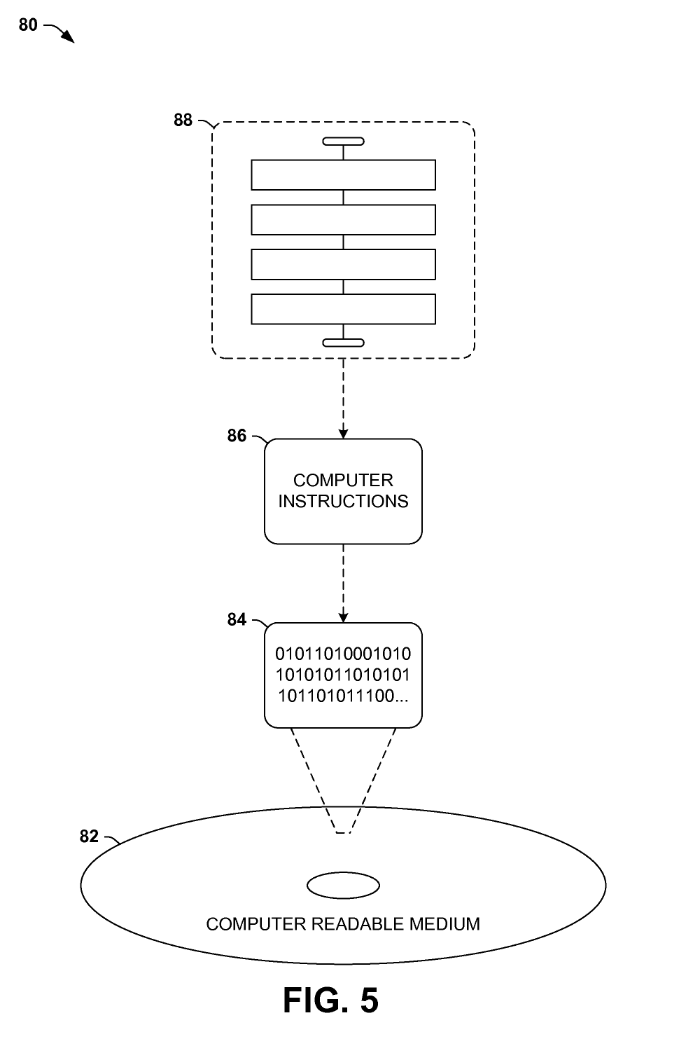

Still another embodiment involves a computer-readable medium comprising processor-executable instructions configured to apply the techniques presented herein. An exemplary computer-readable medium that may be devised in these ways is illustrated in FIG. 5, wherein the implementation 80 comprises a computer-readable medium 82 (e.g., a CD-R, DVD-R, or a platter of a hard disk drive), on which is encoded computer-readable data 84. This computer-readable data 84 in turn comprises a set of computer instructions 86 configured to operate according to the principles set forth herein. In one such embodiment, the processor-executable instructions 86 may be configured to perform a method of presenting search results in response to a search query received from a user having a social profile, such as the exemplary method 40 of FIG. 3. In another such embodiment, the processor-executable instructions 86 may be configured to implement a system for presenting search results in response to a search query received from a user having a social profile, such as the exemplary system 66 of FIG. 4. Some embodiments of this computer-readable medium may comprise a non-transitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

The techniques presented herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 40 of FIG. 3 and the exemplary system 66 of FIG. 4) to confer individual and/or synergistic advantages upon such embodiments.

A first aspect that may vary among embodiments of these techniques relates to the scenarios wherein the techniques may be utilized. As a first example, the data set 16 may comprise many types of data items 18, including web resources (such as web pages of various websites) identified by a uniform resource identifier (URI), a set of media objects (such as images, video and audio recordings, and text documents) stored in a media library, and a set of advertisements stored in an advertisement set. As a second example of this first aspect, the search query 14 may be specified in many ways, such as a natural language query, a keyword query, a logical query featuring criteria connected by Boolean logical operations, and a query specified in a structured query language (SQL). As a third example of this first aspect, many types of social profiles 22 may be generated by the user 12 and utilized to predict the user interests 36 of the user 12 in various topics 34 associated with the search results 20, including a professional networking profile and an academic profile. Those of ordinary skill in the art may devise many scenarios wherein the techniques presented herein may be advantageously utilized.

A second aspect that may vary among embodiments relates to the architectures of implementations of these techniques. One such architecture is presented as the exemplary system 66 in the exemplary scenario 60 of FIG. 4, but many other architectures may be selected, some of which may present additional advantages. As a first example, the components of the exemplary system 66 of FIG. 4 may be refactored; e.g., instead of the search results 20 being delivered to the search result evaluating component 70, the search results 20 might be delivered to the search query applying component 68, which may retain the search results 20 until adjusted by the search result adjusting component 72. As a second example of this second aspect, the search query applying component 68 (e.g., a search engine) may be implemented as part of the exemplary system 66, or may be implemented separately (e.g., by the data set 16, or by an intermediate component outside of the exemplary system 66.) As a third example of this second aspect, the data set 16 may comprise a single data store of data items 18 that may be selected as search results 20 in response to a search query 14. Alternatively, the data set 16 may be distributed across several data stores, each of which may store a particular type of data item 18 (e.g., a first data store may store images, a second data store may store video recordings, and a third data store may store audio recordings), but the data stores may be treated as a single data set 16 from which a varied set of search results 20 may be selected and returned. Those of ordinary skill in the art may devise many variations in the architectures of embodiments of the techniques presented herein.

A third aspect that may vary among embodiments of these techniques relates to the manner of identifying topics 34 that are associated with respective search results 14. As a first example, various topics 34 may be associated with one or more topical identifiers, such as a keyword, a name, a tag, or a reference to a list of topics. Identifying the topics 34 associated with a search result 20 may therefore comprise detecting the at least one topical identifier within the search result 20. For example, a status message posted in a social network may include a “hashtag,” comprising a hash symbol followed by the name of the topic 34 (ending with a whitespace character), such as “#tennis” or “#swimming”, so identifying the topic 34 associated with the message may simply comprise detecting the presence of the hashtag and extracting the name of the topic 34. A content item 20 formatted according to a hypertext markup language (HTML) variant may also specify the topical identifiers in a particular tag, such as a meta tag that specifies a set of topical keywords associated with the document. As a second example, an evaluation may be performed on the contents of the search result 20 to identify the topics 34 involved, such as a natural-language evaluation algorithm applied to a textual content item 20 (such as a human-readable web page) or an image evaluation algorithm applied to an image. This evaluation may also include the use of artificial intelligence techniques, such as artificial neural networks or genetic algorithms that have been trained to identify the topics 34 associated with various content items 20, or by involving individuals in the identification of topics 34 associated with content items 20. The evaluation may also utilize various statistical language modeling techniques, such as information extraction techniques, in order to identify the contents of the search result 20 in order to identify related topics 34. Those of ordinary skill in the art may devise many ways of identifying the topics 34 associated with various content items 20 while implementing the techniques presented herein.

A fourth aspect that may vary among embodiments of these techniques relates to the manner of predicting the user interest 36 in the topics 34 associated with various content items 20 based on the social profile 22 of the user 12. As a first example, the social profile 22 of the user 12 may include a large amount of information, including the profile elements 24 that are created by the user 12 (e.g., demographic traits of the user 12, user groups with which the user 12 is involved, and events attended by the user 12.) The aspects of the social profile 22 of the user 12 used in the prediction of user interest 36 may also include the number and types of associations 26 between the user 12 and associated users 28, as well as various data items generated by the user 12 and/or shared by the user 12 with associated users 28 within the social network. The social profiles 22 of the associated users 28 (e.g., demographic traits of the associated users 28, user groups with which the associated users 28 are involved, and events attended by the associated users 28) may also be relevant for inferring the user interests 36 of the user 12; if a friend of the user 12 is interested in a particular topic 36, the user 12 may be interested as well.

In addition, other sources of information about the user 12 may be included in the social profile 22 of the user 12 that is used to identify the user interests 36 of the user 12. For example, the social profile 22 of the user 12 may also include information based on various computing activities of the user 12 and the associated users 28 within the social network; e.g., if the associated users 28 of the user 12 share with the user 12 various content items that are associated with various topics 34, the user interests 36 of the user 12 may be inferred based on which content items the user 12 chooses to view, how long the user 12 spends viewing these content items, and whether the user 12 takes follow-up actions regarding such content items, such as bookmarking, saving, commenting on, or reposting such content items. The social profile 22 of the user 12 may also include information based on the computing activities of the user 12 with the data set 16, such as previously submitted search queries 14 and the actions of the user 12 regarding the search results 20 accordingly presented. The social profile 22 may also include aspects of the user 12 that are inferred from communications of the user 12 within the social network. For example, the user 12 may author a message to another user that references a piece of demographic information about the user 12, particular topics of interest to the user 12, or an event that the user 12 may be attending. The content of respective messages may be evaluated (either when the message is submitted, or when the user interests 36 of the user 12 are evaluated) to identify various user interests 36 expressed therein, and may be included in the social profile 22 of the user 12 to be utilized by the techniques presented herein.

All of these aspects of the social profile 22 of the user 12, as well as the associated users 28 who have associations 26 with the user 12, may be used to predict the user interest 36 of the user 12 in various topics 34. As a second example of this fourth aspect, many techniques may be utilized to perform the prediction based on this diverse set of information. As a first variation, the social profile 22 of the user 12 may be evaluated in the abstract to identify topics 34 in which the user 12 may have a user interest 36, and these topics 34 may be compared with the topics 34 identified with respective search results 20 to select the search results 20 in which the user 12 may have a user interest 36. The evaluation of the social profile 22 may be performed ad hoc, e.g., between selecting the search results 20 in response to the search query 14 and adjusting the search results 20. Alternatively, the evaluation may be performed at an earlier time, such that the set of topics 34 in which the user 12 may have a user interest 36 is available to facilitate the presentation of search results 20 in response to any search queries 14 received from the user 12. An earlier evaluation of the social profile 22 may be advantageous for permitting an indefinitely sophisticated (and potentially resource-consuming) evaluation of the social profile 22 without extending the turnaround time in presenting the search results 20 for a search query 14 (as may occur with ad hoc evaluation), but may be disadvantageous by involving ongoing reevaluation as the social profile 22 of the user 12 changes in order to avoid staleness (e.g., adjusting search results 20 based on an outdated model of the user interests 36 of the user 12.) As a second variation, rather than evaluating the social profile 22 in the abstract, an embodiment may first identify the topics 34 associated with various the search results 20, and may then examine the social profile 22 of the user 12 to predict the user interest 36 of the user 12 in the respective topics 34. For example, upon identifying that a particular search result 20 relates to the topic of tennis, the social profile 22 of the user 12 may be examined to detect any indication that the user 12 has any user interest 36 in tennis. While this variation is performed in an ad hoc manner and may affect the performance of the response to the search query 14, it may be more efficient to check the social profile of the user 12 for interest in particular topics 34 (where such determination is of imminent value) than to generate an exhaustive list of all topics 34 in which the user 12 may have a user interest 36, where only some of these topics 34 may arise in the search results 20.

As a fourth example of this third aspect, the pieces of information comprising the social profile 22 of the user 12 may be used in a direct manner to predict the user interests 36 of the user 12 in various topics 34 (e.g., using the membership of the user 12 in a user group formed to discuss the sport of tennis as a prediction that the user 12 may be interested in a search result 20 associated with the topic 34 of tennis.) Alternatively or additionally, metadata about the components of the social profile 22 of the user 12 may also be utilized in this prediction. As a first variation, the prediction and subsequent adjusting may be based in part on the age of the aspects of the social profile 22 of the user 12. For example, a profile element 24 indicating a user interest 36 in a particular topic 34 that has been recently added by the user 12 may indicate a strong user interest 36 in the topic 34, while a profile element 24 that was added a long time ago may indicate a weaker user interest 36 in the topic 34, particularly if no recently added or updated profile elements 24 indicate a continuing or renewed user interest 36 in the topic 34.

As a second variation of this fourth example of this third aspect, the prediction and subsequent adjusting may be based in part on the nearness of the aspects of the social profile 22 of the user 12. For example, an indication of a user interest 36 in a particular topic 20 expressed by the user 12 may be highly predictive of the user interest 36 of the user 12 in a particular content item 20, but an indication of a user interest 36 in the topic 20 expressed by an associate user 28 may also be predictive (although less strongly predictive.) Additionally, an indication of user interest 36 in a particular topic 20 expressed by an associated user 28 who has a close relationship with the user 12 may be more predictive of the user interests 36 than a similar expression by an associated user 28 who has a more distant relationship with the user 12. This “nearness” factor of the aspect of the social profile 24 to the user 12 may be indicative of the predictiveness of the aspect in the user interest 36 of the user 12 in the topic 20.

As a third variation of this fourth example of this third aspect, the prediction and subsequent adjusting may be based in part on user reviews of a particular topic 20 expressed by the user 12 and/or associated users 18. In addition to merely indicating a user interest 36 in a particular topic 20, a user 12 may attribute a user review to various properties of the topic 20, such as the magnitude of the user interest 36 (e.g., “I'm very interested in product X, but not at all interested in product Y”) or the quality of the topic 20 (e.g., “product X looks like it has much better features than product Y.”) The user rating may be quantitative (e.g., including a rating scale defined by the user 12 or the social network) or qualitative (e.g., inferred from a qualitative comment, such as “the service at restaurant X was great, but not as good as the service at restaurant Y.”) While the existence of the user review in the topic 20 may be predictive of the user interest 36 in the topic 20, the contents of the user review may also be identified and used to predict the user interest 36 in the topic 20 and to adjust accordingly the search results 20. For example, while the detection that many associated users 28 in the social network of the user 12 are posting social data items relating to a particular topic 20 may positively predict a user interest 36 of the user 12 in the topic 20, a more sophisticated evaluation may detect whether such social data items positively or negatively reflect on the topic 20 (e.g., if many friends of the user 12 are posting social data items that are critical of the topic 20, the user 12 might have little or no user interest 36 in the topic 20.)

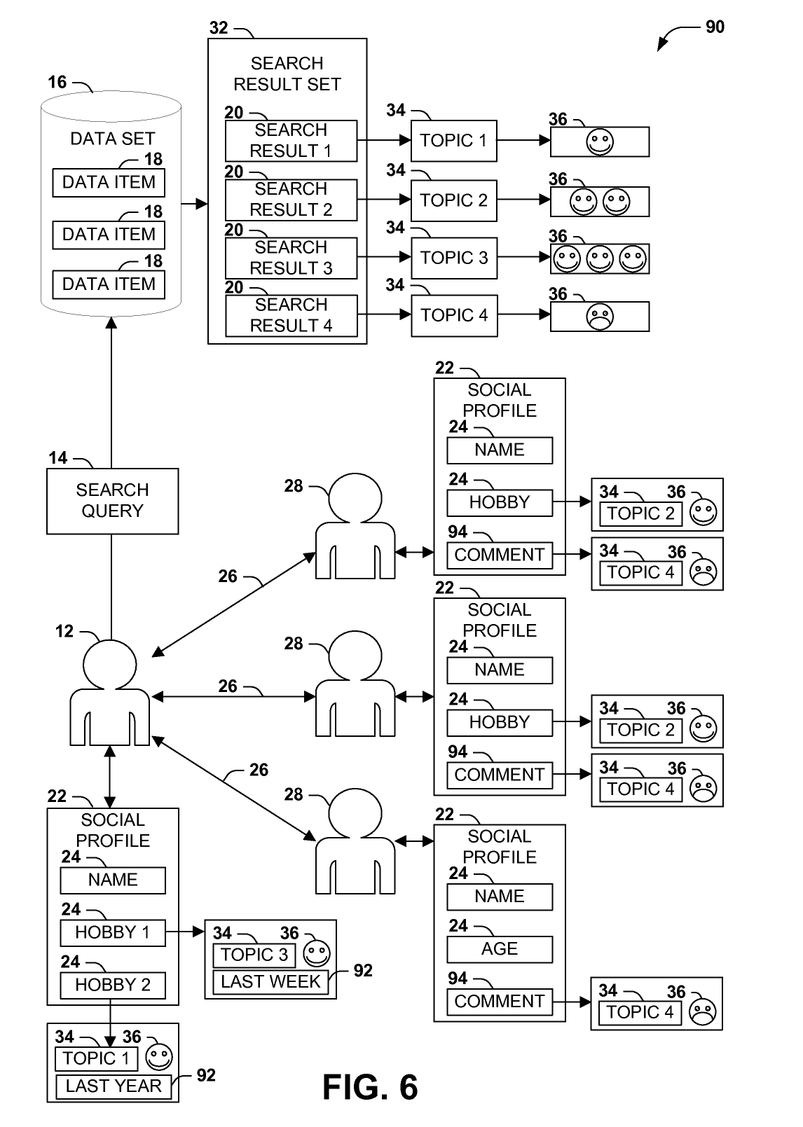

FIG. 6 presents an exemplary scenario 90 featuring the prediction of user interest 36 in various topics 20 based on some metadata factors of respective aspects of the social profile 22 of the user 12 (including the social profiles 22 of the associated users 28 who have associations 26 with the user 12.) In this exemplary scenario 90, the user 12 submits a search query 14 to a data set 16, which selects search results 20 from among the indexed data items 18, and in accordance with the techniques presented herein, the search results 20 may be adjusted according to the predicted user interest 36 of the user 12 in the topics 34 associated with the search results 20. As a first example, the first search result 20 is identified as being associated with a first topic 34, which the user 12 notes as an interest in the social profile 22, and an embodiment may presume that the user 12 has a user interest 36 in the first topic 34. Similarly, the third search result 20 is identified as being associated with a third topic 34, which the user 12 notes as an interest in the social profile 22, and an embodiment may presume that the user 12 has a user interest 36 in the third topic 34. However, the notation by the user 12 of the user interest 36 in the first topic 34 may have an age 92 indicating that the notation was created a year ago, whereas the notation by the user 12 of the user interest 36 in the third topic 34 may have an age 92 indicating that the notation was added last week. Accordingly, the user interest 36 in the third topic 34 may be predicted as significantly greater than the user interest 36 in the first topic 34, and the search results 20 associated with the respective topics 34 may be accordingly adjusted.

As a second example illustrated in FIG. 6, a second search result 20 may be identified as associated with a second topic 34, several associated users 28 who have associations with the user 12 may have noted a user interest 36 in the second topic 34. However, the nearness of these expressions of user interest 36 (as having been expressed by associated users 28 of the user 12, each of which may have a different type and magnitude of association 26 with the user 12) may be considered while comparing the user interest 36 in the second topic 34 with the user interest 36 in the first topic 34 and the third topic 34, and the second topic 34, while predicted as evoking less user interest 36 of the user 12 than the third topic 34, may be predicted as evoking more user interest 36 of the user 12 than the first topic 34.

As a third example illustrated in FIG. 6, a fourth search result 20 may be identified as associated with a fourth topic 34, and several associated users 28 of the user 12 may have created content items referencing the fourth topic 34. However, these comments may express user reviews 94 of the fourth topic 34 that negatively portray the fourth topic 34. Accordingly, the user interest 36 of the user 12 in the fourth topic 34 may be predicted as low or negative, and the fourth content item 20 associated with the fourth topic 34 may accordingly be adjusted below the other content items 20 associated with the other topics 34. In this manner, the metadata factors about the aspects of the social profile 22 of the user 12 may be included in the prediction of user interest 36. Those of ordinary skill in the art may devise many ways of using the social profile 22 of a user 12 to predict the user interest 36 of the user 12 in various topics 34 while implementing the techniques presented herein.

A fourth aspect that may vary among embodiments relates to the manner of adjusting the search results 20 in response to the predicted user interest 36 of the user 12 in the topics 34 associated therewith. Many search engines (such as the data sets 16 described herein) may produce a set of search results 20 in an original order, such as a predicted order of relevance to the search query 14; and in accordance with the present techniques, it may be advantageous to adjust the search results 20 according to the predicted user interest 36 in the topic(s) 34 of each search result 20, based on the information contained in the social profile 22 of the user 12. However, as a first example, the adjusting 56 may be performed while taking into account the original order of the search results 20 identified by the data set 16. As a first variation, if the user interest 36 in two search results 20 is predicted to be equivalent, then these search results 20 may be adjusted according to the relative positions of these search results 20 in the original order generated by the data set 12 (e.g., by positioning one search result 20 before another search result 20 based on the relative relevance of these search results 20 to the search query 14, as determined by the data set 16.) As a second variation, the adjusting 56 may, instead of completely adjusting the search results 20, adjust each search result 20 a limited number of positions within the original order of the search results 20 (e.g., moving each search result 20 up or down a maximum of five positions in the original order.) These variations may therefore respect both the predicted user interest 36 in the respective search results and the relevance of the search results 20 to the user query 14, as indicated by the data set 16 in the original ordering of the search results 20.

As a second example of this fourth aspect, the adjusting of the search results 20 may adjust the indication of the new order in many ways. As a first variation of this second example, where the search results 20 are to be presented in a strict linear order (e.g., a vertical order in descending order of predicted relevance to the search query 14), the adjusting may reposition the search results within the linear order. As a second variation of this second example, if the search results 20 comprise images selected from a data set 16 comprising an image database, the search results 20 may be presented as a tiled set of thumbnails comprising previews of the respective images, with the highest ordered images presented in the center of a search result region of the display and increasingly lower-ordered images radiating out from the center. As a third variation of this second example, if the search results 20 comprise thumbnail representations of images, the adjusting may involve (in addition to selecting new positions for the thumbnails based on the predicted user interest 36) scaling the thumbnails according to the predicted user interest 36, such that the thumbnail corresponding to an image having a comparatively high predicted user interest 36 may appear larger (and more attention-grabbing) than the thumbnail corresponding to an image having a comparatively low predicted user interest 36.

As a third example of this fourth aspect, search results 20 that are predicted as having a comparatively low user interest 36 may be entirely removed from the adjusted result set 20 and from the subsequent presentation of search results 20. For example, an embodiment may compute a user interest score of the predicted user interest 36 of the user 12 in respective search results 20, may compare the user interest score with a user interest score threshold defined by the embodiment, and may remove from the set of search results 20 any search result 20 having a user interest score below the user interest score threshold. Similarly, for search results 20 that involve a topic 34 that is the subject of a user review 94 by a user 12 of the social network (including associated users 28 who have associations with the user 12), a user rating may be computed and compare a user rating threshold defined by the embodiment, and an embodiment of these techniques may remove from the set of search results 20 and the subsequent presentation thereof any search result 20 having a user rating below the user rating threshold. In some scenarios, these thresholds may be set comparatively high, such that only search results 20 having a high predicted user interest 36 and/or a high user rating may be presented, thereby leading to a highly selective presentation of search results 20 to the user 12. One scenario where a high threshold may be advantageous is in the selection and presentation of advertisements. By utilizing a high threshold of predicted user interest 36 in presented advertisements, an embodiment may restrict the presentation of an advertisement to scenarios where the persuasiveness of the advertisement is likely to be high, and may avoid presenting the advertisement in less persuasive circumstances. Additionally, the high threshold of predicted user interest 36 in presented advertisements may reduce the burial of a highly relevant or highly interesting advertisement among less effective advertisements. These advantages may improve the effectiveness of the advertisement (e.g., as measured by click-through rate or ensuing sales per number of presentations of the advertisement.) Those of ordinary skill in the art may devise many techniques for adjusting the search results 20 according to the techniques presented herein.

A fifth aspect that may vary among embodiments of these techniques relates to the presentation of adjusted search results 20 to the user 12. As a first example, the adjusting 54 may be performed by a device operated by the user 12, and the presenting 56 may comprise displaying the search results 20 on a display component of the device. Alternatively, the adjusting 54 may be performed by a different device than that operated by the user 12, and the presenting 56 may comprise sending to a device operated by the user 12 a presentation of the adjusted search results 20, e.g., by generating a web page (such as an HTML document) and delivering it to a device operated by the user 12 for rendering by a web browser executing on the device and displaying on a display component of the device.

As a second example of this fifth aspect, the presenting 56 of search results 20 (in a manner that indicates the adjusting 54 thereof) may be achieved in many ways. As a first variation, the search results 20 may be presented in a linear manner, with the search result 20 having the highest predicted user interest 36 positioned at the top of the presentation, and other search results 20 presented below the first search result 20 in order of decreasing predicted user interest 36. As a second variation, search results 20 comprising images may be presented as a grid of thumbnail representations thereof, with each thumbnail representation being selectable to view the original image. In this second variation, the adjusting 54 of the search results 20 may be indicated by positioning the search result 20 having the highest predicted user interest 36 in a corner (e.g., the upper-left corner) of the grid and positioning the other search results 20 in order of decreasing predicted user interest 36, or by positioning the search result 20 having the highest predicted user interest 36 in the center of the grid and presenting the other search results 20 radiating outward from the center, with the distance from the center inversely proportional to the predicted user interest 36 in the search result 20. Alternatively or additionally, the adjusting 54 may indicate the adjusting of user interest 36 in other ways, e.g., by explicitly indicating the predicted user interest 36 (e.g., with different icons or text labels indicating “high user interest predicted,” “medium user interest predicted,” and “low user interest predicted”), or by scaling the thumbnail representations of search results 20 proportionally to the predicted user interest 36, with the largest thumbnail representations indicating the search results 20 of highest predicted user interest 36.

A particular variation of this second example of this fifth aspect relates to the presentation of search results 20 relating to content items (e.g., the data items 18 that are targeted by the search query 14) along with the presentation of advertisements (e.g., as a technique for achieving sponsorship of the data set 16.) For example, upon receiving a search query 14 from the user 12, an embodiment of these techniques may submit the search query 14 to several data sets 16 of different data set types, including a first data set 16 comprising an index of a set of web resources (e.g., web pages) and a second data set 16 comprising an index of advertisements respectively advertising at least one product or service. Each data set 16 may apply the search query 14 to the indexed data items 18, and the embodiment may generate a presentation of these data items 18 that both fulfills the search query 14 of the user 12 and presents advertisements that may offset the administrative costs of the embodiment. The embodiment may generate this presentation in various ways. As a first example, the embodiment may be configured to present the search results 20 in a visual user interface (such as a web page rendered within a web browser), where the search results 20 comprising web resources are positioned in a first region of the visual user interface, and the search results 20 comprising advertisements are positioned in a second region of the visual user interface that does not overlap the first region. As a second example, the embodiment may be configured to present all of the search results 20 in a region of the visual user interface, where the search results 20 comprising advertisements are interleaved with the search results 20 comprising web resources.

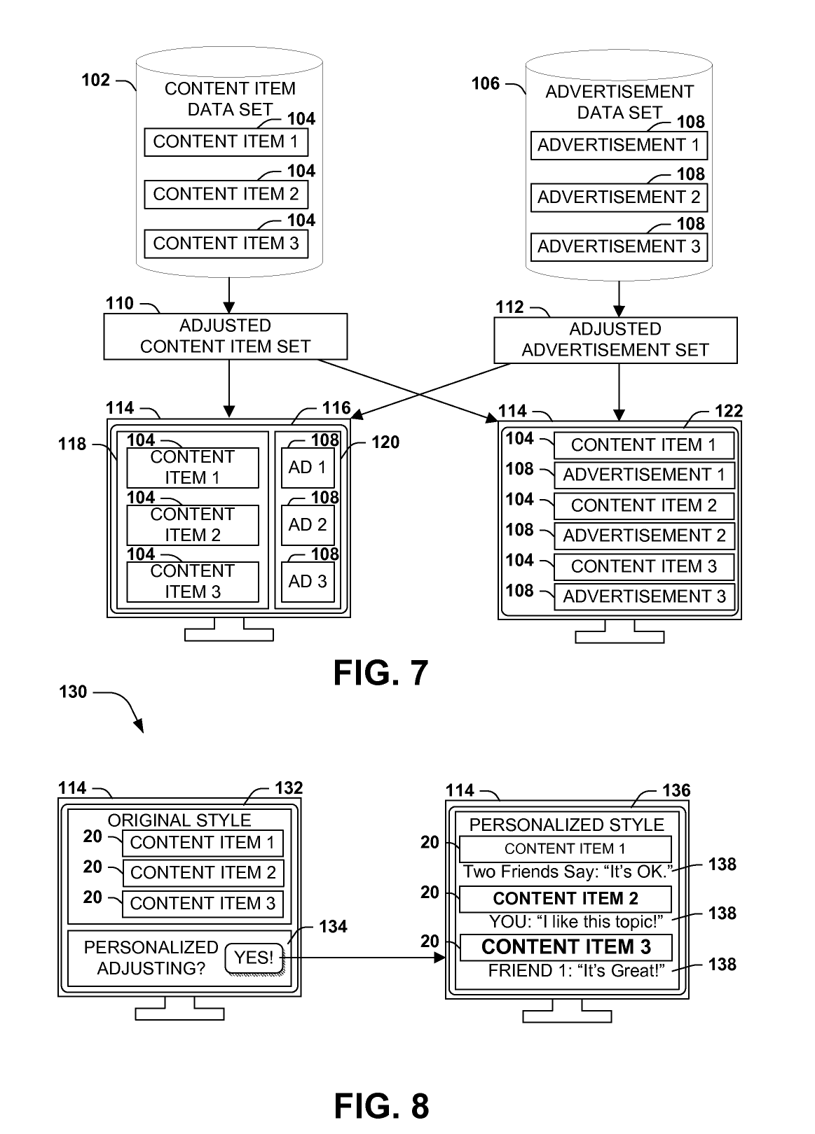

FIG. 7 presents an illustration of an exemplary scenario featuring two presentations of adjusted search results 20 selected from two data sets 16 in response to a user query 16, comprising a set of content items 104 selected from a content item data set 102 (e.g., links to web pages matching the user query 14) and a set of advertisements 108 selected from an advertisement data set 106. After adjusting the selected content items 104 to produce an adjusted content item set 110 and adjusting the selected advertisements 108 to produce an adjusted advertisement set 112, these search results 20 may be presented in different ways. As a first example, a display 114 of a device owned by the user 12 may present the search results 20 in a first exemplary presentation 116, where the adjusted content item set 110 is presented in a first region 118 of a visual user interface (such as a web browser) rendered on the display 114, and the adjusted advertisement set 112 is presented in a second region 120 of the display 114 that does not overlap the first region 118. This exemplary first presentation 116 may be advantageous for reducing the intrusion of the advertisements 108 in the content items 104 requested by the user 12, while still peripherally presenting the advertisements 108 to attract the attention of the user 12. As a second example, the display 114 of the device owned by the user 12 may present the search results 20 in a second exemplary presentation 122, wherein the search results 20 are presented together in a region of a visual user interface (such as a web browser) rendered on the display 114 as a set of content items 104 interleaved with the advertisements 108. This exemplary second presentation 122 may be advantageous for attracting greater attention of the user 12, and may be particularly suitable if the advertisements 108 also provide information that the user 12 wishes to view (e.g., if the search query 14 relates to a particular product and the advertisements 108 present information and offers for the product.)

As a third example of this fifth aspect, the presenting 56 of adjusted search results 20 may be performed unobtrusively, e.g., by simply utilizing the social profile 22 of the user 12 and presenting reordered search results 20 without indicating any such use or reordering. Alternatively, the presenting 56 may be adjusted in many ways that explicitly reflect the relationship of the adjusting 56 with the social profile 22 of the user 12. As a first variation of this third example, many types of visual adjusting may be applied to the search results 20. For example, the presenting 56 of search results 20 to the user 12 may involve adjusting respective search results 20 according to one or more presentation adjustments, which may be selected from a set of presentation adjustments, such as adjusting the font size of the search result 20 proportionally to the user interest 36 predicted in the topic 34 of the search result 20; adjusting the font emphasis (e.g., bolding, italicizing, or underlining) associated with the user interest 36 predicted in the topic 34 of the search result 20; adjusting the font color associated with the user interest 36 predicted in the topic 34 of the search result 20 (e.g., presenting search results 20 having higher predicted user interest 36 in bolder or brighter colors); and adjusting a search result border style associated with the user interest 36 predicted in the topic 34 of the search result 20 (e.g., showing thicker or different borders for search results 20 having higher predicted user interest 36.) Many such presentation adjustments may be selected to identify the adjustment of the search results 20 based on the predicted user interest 36 therein.

As a second variation of this third example, where the search results 20 are initially sorted according to an original order, an embodiment may present the search results 20 to the user 12 in a visual user interface (such as a web browser) in the original order, and may also present to the user 12 an offer to adjust the search results 20 in a personalized manner according to the social profile 22 of the user 12; and upon receiving from the user 12 an acceptance of the offer, the embodiment may present the search results 20 to the user 12 in the visual user interface adjusted according to the social profile 22.

As a third variation of this third example, along with the adjusted search results 20, an embodiment may present an adjusting criterion, which may indicate the criterion for adjusting the search result 20 (e.g., the reason for presenting the search result 20 higher or lower in the search result set according to the social profile 22 of the user 12.) For example, the embodiment may present with a search result 20 that was moved up in the order during the adjusting an indication that the search result 20 relates to a topic 34 in which the user 12 expressed an interest in the social profile 22, or in which associated users 12 expressed an interest or a high user review. Similarly, for search results 20 that were moved down among the search results 20 during the adjusting, the embodiment may indicate why the search result 20 was moved down (e.g., “your friends Joe and Mark gave this product low user ratings.”) However, it may be appreciated that, if an embodiment that has access to a large amount of social network information may insert comments about a search result 20 based on the social profiles 22 and computing activities of other users 12 (including associated users 28 and, possibly, more distant users 12 who have associations 26 with the associated users 28 but not the user 12 who submitted the search query 14), it may occasionally be undesirable to annotate a search result 12 with information derived from the social profiles 22 of these other users 12. For example, a topic 34 that is associated with a particular user 12 (e.g., based on semi-private messages sent to other users 12, or based on search queries 14 submitted by the user 12 to search engines) may be politically sensitive, semi-private, or embarrassing to the user 12 if revealed to others without the consent of the user 12. Therefore, it may be undesirable to annotate the search results 20 with this information, in a manner that identifies the user 12, when other users 12 submit search queries 14 associated with the same topic 34 (e.g., “your friend Joe expressed an interest in this sensitive topic.”) However, it may be acceptable to anonymize the annotations of the search results 20 (e.g., “three of your friends and five of their friends expressed an interest in this sensitive topic.”) Therefore, an embodiment of these techniques may be configured to, for topics 34 adjusted according to a user interest 36 predicted according to a computing activity of at least one associated user 28 who is associated with the user 12 through the social profile 22, anonymize the adjusting criteria presented with search results 20.

As a fourth variation of this third example, where the user interest 36 of the user 12 is predicted based on one or more user reviews of the search result 20, an embodiment may present the user review(s) along with the adjusted search result 20. For example, the search result 20 may include the first few lines of a user review submitted for the topic 20 associated with the search result 20 by an associated user 28 having an association 26 with the user 12 (e.g., “this search result relates to a movie, about which your friend Joe wrote the following: . . . ”) Moreover, where the user reviews include a user rating, such as a score, the search result 20 may be annotated with the user ratings or an aggregate thereof (e.g., “the movie described by this search result has an average rating of four stars out of five among your friends.”)

FIG. 8 presents an exemplary scenario 130 featuring a presentation of search results 20 utilizing several of these variations. In this exemplary scenario 130, the user 12 has submitted a search query 14 for application to a data set 16, and the selected search results 20 have been adjusted according to the predicted user interest 36 based on the social profile 22 of the user 12. In order to complete the presentation of the search results 20, a display 114 of a device operated by the user 12 presents within a visual user interface (such as a web browser) a first presentation 132 of the search results 20, rendered in an original style by the data set 16, along with an offer 134 to adjust the search results 20 in a personalized manner (comprising a description of the offer 134 and a graphical button that may be clicked by the user 12 to accept the offer.) Upon receiving an acceptance of the offer 134 (e.g., a notification that the user 12 has clicked the button), the display 114 may present a second presentation 136 of the search results 20 in the adjusted (“personalized”) style. In particular, while these search results 20 are not reordered, different presentation adjustments are applied thereto, such that the search result 20 having the highest predicted user interest 36 is presented in a large, bolded font, and the search result 20 having the lowest predicted user interest 36 is presented in a small, plain font. Additionally, respective search results 20 may be presented with an adjusting criterion 138 indicating why the search results 20 were adjusted in this manner. The adjusting criteria may also include a summation of user reviews of the search results 20 (e.g., “friend 1 wrote that this topic is great!”), and some search results 20 relating to sensitive topics 20 may be anonymized (e.g., “two of your friends wrote about this search result.”) In this manner, the presentations in the exemplary scenario 130 utilize several of these concepts in achieving the presenting 56 of the adjusted search results 20.

As a fourth example of this fourth aspect, in addition to adjusting the search results 20, an embodiment of these techniques may alter one or more search results 20 based on the social profile 22 of the user 12. For example, one or more data items 18 in the data set 16 may be customizable, such that the data item 18 may be presented as a search result 20 with a customized view relative to particular aspects of the social profile 22 of the user 12. However, when the data item 18 is selected for presentation as a search result 20 in the absence of an accessible social profile 22, or where the social profile 22 of the user 12 is accessible but does not include any information upon which the data item 18 may be customized, the data item 18 may be presented as a search result 20 with an uncustomized view. This example may be particularly advantageous in the context of targeted advertising, where search results 20 comprising advertisements for a product or service may be presented with a customized view of the advertisement based on the social profile 22 of the user 12. For example, the advertisement may be customized based on demographic information of the user 12 (e.g., an advertisement of a television may illustrate the television as displaying a television show that is generally appealing to individuals having similar demographic information as the user 12) or based on the social profiles 22 of associated users 28 who have an association with the user 12 (e.g., “your friends John and Sue recently purchased this product”), or may be present an uncustomized view that generally presents the product or service if the social profile 22 is unavailable or unhelpful in selecting a customized view. In this manner, the search results 20 comprising advertisements that have a high predicted user interest 36 may not only be given higher priority among the search results 20 through adjusting, but may also be specifically targeted to the user 12 based on the social profile 22, thereby increasing the effectiveness of the advertisement. Those of ordinary skill in the art may devise many ways of presenting 56 the search results 20 while implementing the techniques presented herein.

A sixth aspect that may vary among embodiments of these techniques relates to additional uses of the search query 14 in view of the social profile 22 of the user 12. In particular, in addition to presenting search results 20 in response to the search query 14, an embodiment of these techniques may identify one or more topics 34 that are of interest to the user 12 based on the contents of the search query 14, and/or based on the topics 34 associated with search results 20 in which the user 12 expresses an interest (e.g., by visiting, spending time examining, bookmarking, commenting on, or republishing a search result 20.) As a second example, an embodiment may utilize the detected user interests 36 of the user 12 to adjust the search query 14, or to adjust search queries 14 that are subsequently received from the user. For example, if a user 12 is determined to have a particular user interest 36, an embodiment may use this determination to make implicit alterations of the search query 14 (e.g., automatically presuming that if the user 12 is interested in the sport of football and enters a search query for the name of a popular football player, the term “football” may be added to the search query 14 in order to reduce false positives.) The embodiment might also use this information, e.g., to suggest search queries to the user 12 (e.g., “You searched for [name of popular football player]; would you like to restrict this search query to the sport of football?”), or to correct (automatically or by suggestion) misspellings or ambiguities in the search query 14 (e.g., “You searched for ‘fotball’; presumably you meant to search for ‘football’” and “You searched for ‘football’; based on your user interests, this search query is suggested to mean the international sport of soccer instead of the American sport of gridiron.”) Many other uses of the user interests 36 may be devised for application to search queries 14 submitted by the user 12.

As a second example of this sixth aspect, an embodiment of these techniques may be configured to, upon identifying a topic 34 associated with the search query 14, update the social profile 22 of the user 12 to indicate the user interest 36 of the user 12 in the topic 34. However, because the user 12 may not wish to publicize a user interest 36 in every topic 34 associated with his or her search queries 14, the embodiment may be configured to present to the user 12 an offer to update the social profile 22 to indicate the user interest 36 in the topic 34, and to update the social profile 22 only after receiving from the user 12 an acceptance of the offer. As a third example, upon identifying the topic(s) 34 associated with a search query 14 submitted by the user 12, an embodiment may utilize this detected user interest 36 in evaluating other search queries 14 subsequently submitted by associated users 28 of the user 12 associated with the same topics 34 (e.g., by adjusting the search results 20 of the subsequently submitted search queries 14 in view of the earlier submission of the search query 14 by the user 12 and the topics 34 associated therewith.) In this manner, the submission of the search query 14 may be utilized within the social network to document the user interests 36 of the user 12, and/or to improve the presentation of search results 20 of other search queries 14 submitted by other users 12. Those of ordinary skill in the art may devise many additional users of the search query 14 and the topics 34 identified as associated therewith while implementing the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

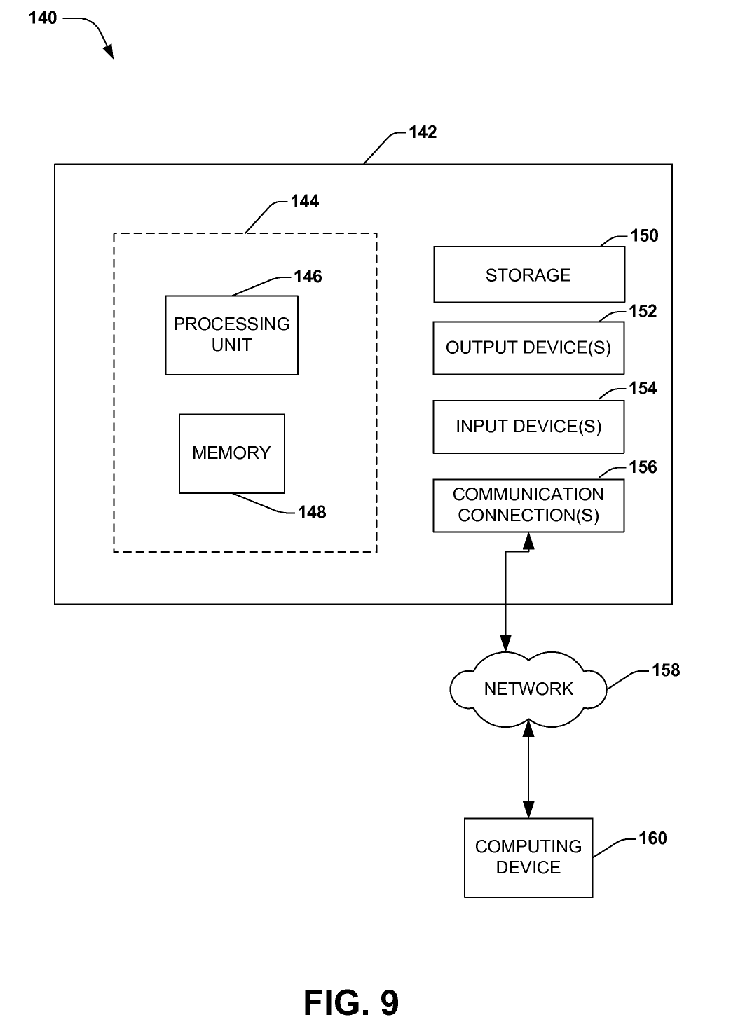

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 140 comprising a computing device 142 configured to implement one or more embodiments provided herein. In one configuration, computing device 142 includes at least one processing unit 146 and memory 148. Depending on the exact configuration and type of computing device, memory 148 may be volatile (such as RAM, for example), non-volatile (such as ROM, flash memory, etc., for example) or some combination of the two. This configuration is illustrated in FIG. 9 by dashed line 144.

In other embodiments, device 142 may include additional features and/or functionality. For example, device 142 may also include additional storage (e.g., removable and/or non-removable) including, but not limited to, magnetic storage, optical storage, and the like. Such additional storage is illustrated in FIG. 9 by storage 150. In one embodiment, computer readable instructions to implement one or more embodiments provided herein may be in storage 150. Storage 150 may also store other computer readable instructions to implement an operating system, an application program, and the like. Computer readable instructions may be loaded in memory 148 for execution by processing unit 146, for example.

The term “computer readable media” as used herein includes computer storage media. Computer storage media includes volatile and nonvolatile, removable and non-removable media implemented in any method or technology for storage of information such as computer readable instructions or other data. Memory 148 and storage 150 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 142. Any such computer storage media may be part of device 142.

Device 142 may also include communication connection(s) 156 that allows device 142 to communicate with other devices. Communication connection(s) 156 may include, but is not limited to, a modem, a Network Interface Card (NIC), an integrated network interface, a radio frequency transmitter/receiver, an infrared port, a USB connection, or other interfaces for connecting computing device 142 to other computing devices. Communication connection(s) 156 may include a wired connection or a wireless connection. Communication connection(s) 156 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 142 may include input device(s) 154 such as keyboard, mouse, pen, voice input device, touch input device, infrared cameras, video input devices, and/or any other input device. Output device(s) 152 such as one or more displays, speakers, printers, and/or any other output device may also be included in device 142. Input device(s) 154 and output device(s) 152 may be connected to device 142 via a wired connection, wireless connection, or any combination thereof. In one embodiment, an input device or an output device from another computing device may be used as input device(s) 154 or output device(s) 152 for computing device 142.

Components of computing device 142 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 142 may be interconnected by a network. For example, memory 148 may be comprised of multiple physical memory units located in different physical locations interconnected by a network.

Those skilled in the art will realize that storage devices utilized to store computer readable instructions may be distributed across a network. For example, a computing device 160 accessible via network 158 may store computer readable instructions to implement one or more embodiments provided herein. Computing device 142 may access computing device 160 and download a part or all of the computer readable instructions for execution. Alternatively, computing device 142 may download pieces of the computer readable instructions, as needed, or some instructions may be executed at computing device 142 and some at computing device 160.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of presenting search results of a data set in response to a search query submitted by a user having a social profile, the method executed on a device having a processor and comprising:
executing on the processor instructions configured to:
apply the search query against the data set to identify at least one search result;
for respective search results:
identify at least one topic that is associated with the search result, and
predict a user interest in the at least one topic of the search result according to the social profile;
adjust the search results according to the user interests; and
present the search results to the user.

2. The method of claim 1, the predicting comprising: predicting the user interest of the user in the at least one topic of the search result according to at least one aspect of the social profile, the at least one aspect selected from a set of social profile aspects comprising:
at least one demographic trait of the user;
at least one user group that includes the user;
at least one event attended by the user;
at least one computing activity of the user;
at least one associated user who is associated with the user;
at least one demographic trait of at least one associated user who is associated with the user;
at least one user group that includes at least one associated user who is associated with the user;
at least one event attended by at least one associated user who is associated with the user; and
at least one computing activity of at least one associated user who is associated with the user.

3. The method of claim 2, the instructions configured to adjust the search query according to the user interests.

4. The method of claim 2, the adjusting comprising: adjusting the search results according to the user interests and an age of the at least one aspect of the social profile used to predict the respective user interests.

5. The method of claim 2:
the at least one aspect comprising a user review including a user rating of a search result; and
the adjusting comprising: adjusting the search results according to the user interests and according to at least one user rating of at least one search result.

6. The method of claim 5, the presenting comprising: presenting to the user the search results annotated with the at least one user rating of a corresponding search result.

7. The method of claim 5, the presenting comprising: presenting to the user the search results having a user rating higher than a user rating threshold.

8. The method of claim 1:
the predicting comprising: computing a user interest score of the user interest of the user predicted in the at least one topic of the search result according to the social profile; and
the instructions configured to remove from the search results the search results having a user interest score below a user interest score threshold.

9. The method of claim 1, the data set selected from a set of data set types comprising:
a set of web resources, and
a set of advertisements for at least one product.

10. The method of claim 9:
the data set comprising a set of web resources and a set of advertisements; and
the presenting comprising: presenting the search results in a visual user interface, the search results comprising web resources positioned in a first region of the visual user interface, and the search results comprising advertisements positioned in a second region of the visual user interface not overlapping the first region.

11. The method of claim 9:
the data set comprising a set of web resources and a set of advertisements; and
the presenting comprising: presenting the search results in a region of a visual user interface, the search results comprising advertisements interleaved with the search results comprising web resources.

12. The method of claim 1, the presenting comprising: presenting the search results to the user adjusted according to at least one presentation adjustment selected from a set of presentation adjustments comprising:
a font size proportional to the user interest predicted in the topic of the search result;
a font emphasis associated with the user interest predicted in the topic of the search result;
a font color associated with the user interest predicted in the topic of the search result; and
a search result border style associated with the user interest predicted in the topic of the search result.

13. The method of claim 1, the presenting comprising:
presenting to the user in a visual user interface the search results in an original order;
presenting to the user an offer to adjust the search results according to the social profile of the user; and
upon receiving from the user an acceptance of the offer, presenting to the user in the visual user interface the search results adjusted according to the user interests.

14. The method of claim 1, the presenting comprising: presenting respective search results with at least one adjusting criterion indicating a criterion for the adjusting of the search result.

15. The method of claim 14, the presenting comprising: for topics adjusted according to a user interest predicted according to a computing activity of at least one associated user who is associated with the user through the social profile, anonymizing the at least one adjusting criterion.

16. The method of claim 1:
at least one search result customizable based on the user interest; and
the presenting comprising:
upon presenting the search result when not adjusted based on the user interests, presenting an uncustomized view of the search result to the user; and
upon presenting the search result when adjusted based on the user interests, presenting a customized view of the search result to the user, the customized view based on the user interests.

17. The method of claim 1, the instructions configured to:
identify the at least one topic associated with the search query, and
update the social profile of the user to indicate the at least one topic identified as associated with the search query.

18. The method of claim 17:
the instructions configured to present to the user an offer to update the social profile to indicate the at least one topic associated with the search query; and
updating the social profile comprising: upon receiving from the user an acceptance of the offer, updating the social profile of the user to indicate the at least one topic identified as associated with the search query.

19. A system configured to present search results of a data set in response to a search query submitted by a user having a social profile, the system comprising:
a search query applying component configured to apply the search query against the data set to identify at least one search result;
a search result evaluating component configured to, for respective search results:
identify at least one topic that is associated with the search result, and
predict a user interest in the at least one topic of the search result according to the social profile;
a search result adjusting component configured to adjust the search results according to the user interests; and
a search result presenting component configured to present the search results to the user.

20. A computer-readable storage medium comprising instructions that, when executed by a processor of a device having access to a data set and a social profile of a user, present search results in response to a query submitted by the user by:
applying the search query against the data set to identify at least one search result;
for respective search results:
identifying at least one topic that is associated with the search result by identifying within the search result at least one topical identifier that is associated with the topic;
predicting a user interest in the at least one topic of the search result according to at least one aspect of the social profile, respective aspects having an age and a nearness to the user, and respective aspects selected from a set of social profile aspects comprising:
at least one demographic trait of the user;
at least one user group that includes the user;
at least one event attended by the user;
at least one computing activity of the user;
at least one associated user who is associated with the user;
at least one demographic trait of at least one associated user who is associated with the user;
at least one user group that includes at least one associated user who is associated with the user;
at least one event attended by at least one associated user who is associated with the user; and
at least one computing activity of at least one associated user who is associated with the user; and
computing a user interest score of the user interest of the user predicted in the at least one topic of the search result according to the social profile;
removing from the search results the search results having a user interest score below a user interest score threshold;
adjusting the search results according to the user interests, the age of the at least one aspect of the social profile, and the nearness of the at least one aspect of the social profile to the user;
presenting to the user in a visual user interface the search results in an original order;
presenting to the user an offer to adjust the search results according to the social profile of the user; and
upon receiving from the user an acceptance of the offer, presenting to the user in the visual user interface the search results adjusted according to the user interests and with at least one adjusting criterion indicating a criterion for the adjusting of the search result, the presenting comprising:
upon presenting the search result when not adjusted based on the user interests, presenting an uncustomized view of the search result to the user; and
upon presenting the search result when adjusted based on the user interests, presenting a customized view of the search result to the user, the customized view based on the user interests;
identifying the at least one topic associated with the search query;
present to the user an offer to update the social profile to indicate the at least one topic associated with the search query; and
upon receiving from the user an acceptance of the offer, updating the social profile of the user to indicate the at least one topic identified as associated with the search query.
